(19) United States
(12) Patent Application Publication
(10) Pub. No.: US 2026/0273554 A1
(43) Pub. Date: Sep. 17, 2026

(54) GAS AND LIQUID COOLANT (GLC) AEROFORCE FOR GENERAL MACHINING APPLICATIONS

(71) Applicant: SMARTEC LTD ISRAEL, Jerusalem (IL)

(72) Inventor: Oz YITZHAK, Tal-El (IL)

(21) Appl. No.: 19/676,979

(22) Filed: May 14, 2026

Related U.S. Application Data
(63) Continuation-in-part of application No. PCT/IL2024/051105, filed on Nov. 20, 2024.
(60) Provisional application No. 63/600,794, filed on Nov. 20, 2023.

(51) Int. Cl. B05B 7/16; B05B 1/26; B23Q 11/10

(52) U.S. Cl. CPC B05B 7/16; B05B 1/265; B23Q 11/1061

(57) ABSTRACT

A gas and liquid coolant (GLC) aeroforce device for generating non aerosol liquid and gas coolant (GLC), leveraging gas and liquid pressure, and ensuring optimal cooling and lubrication, said device featuring high-velocity coolant convergence with either a moderate or sharp transition directing liquid in an annular or non-annular trajectory towards a central or non-central location, said device creates a mixture of pressurized gas and liquid coolant at a convergence, enhancing cooling, lubrication, and chip clearance in metalworking machinery and other applications.

### CROSS REFERENCE TO RELATED APPLICATIONS

This application is a Continuation-in-Part of PCT Application No. PCT/IL2024/051105 having International filing date of Nov. 20, 2024, which claims the benefit of priority of U.S. Provisional Patent Application No. 63/600,794, filed Nov. 20, 2023, the contents of which are all incorporated herein by reference in their entirety.

### FIELD OF THE INVENTION

The present invention relates to metalworking machines. Specifically, the present invention relates to devices for cooling and lubricating metal cutting applications.

### BACKGROUND OF THE INVENTION

In the realm of metalworking machines, the precision and quality of the machining process are paramount, necessitating meticulous attention to various operational aspects. Among these, the cooling and lubrication of the processing point, through the application of a suitable coolant substance, hold a position of paramount importance. This practice serves multifaceted purposes, encompassing the optimization of the machining process itself, the facilitation of efficient chip clearance from the machining area, and the elongation of the operational life of the machining cutting tool.

Effective cooling and lubrication also contribute to minimizing tool wear and reducing the potential for thermal distortion of the workpiece, ultimately translating to improved surface finish and dimensional accuracy of the final product.

However, a significant challenge arises when the available coolant pressure within the metal processing machine proves insufficient to adequately realize these pivotal objectives. A dearth of coolant pressure can lead to compromised cooling and lubrication, undermining the efficiency of the entire machining process.

Atomizers, for instance, utilize a combination of coolant and gas pressure in metalworking processes.

Atomizers function by combining very low-pressure coolant, close to atmospheric pressure, with compressed gas to create a fine mist directed at the cutting area.

This approach reduces coolant consumption, offering economic and environmental advantages compared to using coolant alone.

The atomizers struggle with effective chip removal due to insufficient gas pressure and are less efficient in dissipating heat compared to direct liquid cooling systems.

Traditional remedies for these issues have often involved the incorporation of larger and more potent coolant pumps, which not only escalate operational costs but also impose space constraints within the machine layout.

In view of the above, an efficient and versatile solution to optimize the machining process, without the need for large and costly coolant pumps is required.

Accordingly, it is an object of the present invention to provide an improved and highly efficient device for cooling and lubrication. A compact, low-cost device that can be easily integrated into existing coolant transportation piping, ensuring continuity with established systems while vastly enhancing operational efficiency.

### SUMMARY OF THE INVENTION

Gas liquid coolant refers to the process of mixing gas such as air with a liquid coolant such as emulsion using gas pressure to create a stable, homogeneous mixture. In the context of metalworking machines, this technique ensures that the coolant is effectively aerated, enhancing its cooling and lubricating properties. Gas pressure facilitates the creation of high-speed coolant flow, resulting in improved coverage and thermal management at the machining interface, which leads to better performance and longevity of the cutting tools and workpieces.

The present invention introduces an inventive paradigm to overcome the critical challenge of inadequate coolant pressure in the realm of metalworking machines, thereby revolutionizing machining processes and extending the operational lifespan of cutting tools.

In the domain of metal processing, the efficacy of cooling and lubrication at the processing point holds pivotal significance, influencing process optimization, chip clearance, and the overall durability of machining tools. However, the shortfall of coolant pressure in numerous metal processing machines hinders the attainment of these fundamental objectives.

To address this issue, the integration of a gas and liquid coolant (GLC) aeroforce device emerges as a promising solution. Driven by gas pressure, the gas and liquid coolant (GLC) aeroforce device generates Gas Liquid Coolant (GLC) that envelops the machining area, offering an unprecedented enhancement in cooling, lubrication, and chip clearance.

The gas and liquid coolant (GLC) aeroforce device of the present invention overcomes the above-described challenges of the atomizer by combining high-pressure gas, typically compressed gas, with liquid coolant at pressures normally (but not necessarily) ranging from 2 to 8 bars or other.

This combination increases the velocity and mass of the coolant, enhancing its impact at the cutting point.

The high-pressure interaction improves cooling efficiency by penetrating the thermal barrier between the cutting tool and the raw material while also facilitating superior chip removal. Consequently, the gas and liquid coolant (GLC) aeroforce device significantly extends cutting tool life by minimizing wear and reducing thermal stress, resulting in substantial cost savings through decreased cutting tool replacement frequency.

It should be noted that the key distinction between the atomizer available nowadays and the gas and liquid coolant (GLC) aeroforce device of the present invention lies in their operating principles. That is, the atomizer relies on low-pressure combinations to produce a cooling mist, whereas the gas and liquid coolant (GLC) aeroforce device of the present invention employs high-pressure dynamics of the gas and liquid to deliver superior cooling performance, effective chip dispersion, and extended cutting tool longevity, and thus, provides a more advanced and efficient solution for modern metal cutting applications. Thus, the present invention introduces an avant-garde geometric configuration that orchestrates an optimal confluence between coolant and gas pressure. This ingenious arrangement facilitates the creation of GLC across a diverse spectrum of operational pressures, providing a dynamic and adaptable solution that harmonizes seamlessly with varying working conditions, all without necessitating substantial system alterations. The crux of the present invention lies in its ability to seamlessly integrate the gas and liquid coolant (GLC) aeroforce device into prevailing coolant transportation piping systems. By streamlining this assimilation process, the present invention eliminates the need for extensive infrastructural modifications, ushering in a remarkable synergy of cutting-edge technology and existing setups.

Notably, the incorporation of GLC technology stands as an efficacious response to the challenges posed by insufficient coolant pressure, while mitigating the requirement for large-scale coolant pumps. The result is a harmonious convergence of cost-effectiveness, spatial efficiency, and heightened operational performance within the realm of metalworking machinery.

The present invention presents a transformative solution that enriches the performance of metal processing machines through the art of GLC. The distinctive geometric design at its core empowers the creation of GLC over a dynamic range of working pressures, unlocking newfound dimensions of cooling, lubrication, and chip clearance efficiency.

In effect, the present invention ushers in an era defined by adaptive, efficient, and sustainable metalworking processes, thereby fostering elevated levels of precision, productivity, and cutting tool longevity in diverse machining operations.

Thus, the gas and liquid coolant (GLC) aeroforce device of the present invention enhances cooling efficiency, reduces thermal deformation of workpieces, and extends cutting tool life. The gas and liquid coolant (GLC) aeroforce device of the present invention is designed to accommodate a wide range of metalworking machines by allowing for the adjustment of internal throttles, thereby enabling control over the movement of the coolant and gas. By adjusting flow rates, pressures, and velocities, the gas and liquid coolant (GLC) aeroforce device ensures optimal conditions at the point of connection between the coolant and gas, resulting in a gas-liquid-coolant (GLC) output that is fully customized to meet the customer's specific requirements based on the existing infrastructure of the machine in use.

Furthermore, the gas and liquid coolant (GLC) aeroforce device aids in the efficient clearance of chips and swarf from the machining area, preventing chip buildup that could otherwise impede the machining process.

The pivotal advantage of the gas and liquid coolant (GLC) aeroforce device lies in its ability to augment machine performance without necessitating the implementation of a bulky and expensive coolant pump.

By capitalizing on gas pressure to create GLC, the gas and liquid coolant (GLC) aeroforce device of the present invention operates with a reduced infrastructure footprint, making it an economical and space-efficient alternative. This breakthrough concept paves the way for enhanced operational efficiency and reduced overhead costs.

The innovative framework elucidated in this invention is designed to seamlessly integrate the gas and liquid coolant (GLC) aeroforce device into the existing coolant transportation piping infrastructure. This integration not only simplifies the adoption of GLC technology into metal processing machines but also preserves the continuity of established coolant delivery systems.

The following sections will detail the operational mechanics, the advantages, the ability to adapt to diverse metalworking processes and the potential to transform the landscape of metalworking machines.

Thus, in accordance with some embodiments of the present invention, there is provided a gas and liquid coolant (GLC) aeroforce device for generating liquid and gas coolant (GLC), leveraging gas and liquid pressure, and ensuring optimal cooling and lubrication, said device featuring high-velocity coolant convergence with a sharp transition directing liquid in an annular or non-annular trajectory towards a central or non-central location, said device creates a mixture of pressurized gas and liquid coolant at a convergence, enhancing cooling, lubrication, and chip clearance in metalworking machinery and other applications.

Furthermore, in accordance to some embodiments of the present invention, the gas and liquid coolant (GLC) aeroforce comprising:
gas and liquid coolant exit component; wherein, in said gas and liquid coolant exit component liquid is integrated with pressurized gas to create a high-pressure coolant,
pressurized gas introduction component through which pressurized gas enters the gas and liquid coolant (GLC) aeroforce device;
coolant introduction component through which liquid enters the gas and liquid coolant (GLC) aeroforce device; said coolant introduction component comprising at least one passage to facilitate flow of said liquid to said gas and liquid coolant exit component and an edge element located in proximity to an exit point of said at least one passage,
   wherein said edge element altering the movement dynamics of the liquid coolant as the liquid emerges from the at least one passage, the edge element redirecting the liquid's movement from its initial axial flow direction to a radial trajectory directed toward a desired location, and
   wherein as the liquid converges toward a desired location, it is interfacing with an introduced pressurized gas,
   thereby the liquid-gas interface is transformed into the gas and liquid coolant intended for cooling and lubrication.

Furthermore, in accordance to some embodiments of the present invention, the edge element is a sharp edge element.

Furthermore, in accordance to some embodiments of the present invention, the desired location is in a pivotal component.

Furthermore, in accordance to some embodiments of the present invention, the desired location in a pivotal component is the center of said pivotal component.

Furthermore, in accordance to some embodiments of the present invention, the at least one passage is at least one axial bore designed to facilitate the flow of liquid from said coolant introduction component of said liquid to said gas and liquid coolant exit component.

Furthermore, in accordance to some embodiments of the present invention, the gas is directed into the gas and liquid coolant (GLC) aeroforce device through a connector situated within the pressurized gas introduction component.

Furthermore, in accordance to some embodiments of the present invention, the coolant introduction component further comprises an outlet ball connection designed to establish a robust and secure connection between the coolant introduction component and a transportation pipeline to ensure a reliable flow the coolant.

Furthermore, in accordance to some embodiments of the present invention, the coolant introduction component further comprises an outlet nut connection designed to ensure a reliable flow of coolant.

Furthermore, in accordance to some embodiments of the present invention, the gas and liquid coolant (GLC) aeroforce device further comprising means for adjusting the coolant flow and/or the gas flow to optimize system performance in relation to actual infrastructure conditions.

Furthermore, in accordance to some embodiments of the present invention, the means for adjusting the coolant flow and/or the gas flow are screws allowing for the narrowing of liquid passage and gas passage.

Furthermore, in accordance to some embodiments of the present invention, the gas and liquid coolant (GLC) aeroforce device incorporates hexagonal elements which are accessible to a user for adjustments of the liquid pressure, and the gas pressure.

Furthermore, in accordance to some embodiments of the present invention, the gas and liquid coolant (GLC) aeroforce device further comprises multiple gaskets to seal the components, thus, to prevent premature mixing of the coolant and gas, and/or to prevent unwanted coolant leakage.

Furthermore, in accordance to some embodiments of the present invention, the gas flows in the center of the gas and liquid coolant (GLC) aeroforce device and the liquid flows around the gas in at least one designated passage.

Furthermore, in accordance to some embodiments of the present invention, the gas flows in the center of the gas and liquid coolant (GLC) aeroforce device and the liquid meets the gas at a certain angle.

Furthermore, in accordance to some embodiments of the present invention, the gas flows in the center of the gas and liquid coolant (GLC) aeroforce device and the liquid meets the gas vertically.

Furthermore, in accordance to some embodiments of the present invention, the liquid flow speed and/or the gas flow speed is increased by reducing the cross-sectional area of the at least one passage.

Furthermore, in accordance to some embodiments of the present invention, the gas is selected from air and Nitrogen.

Furthermore, in accordance to some embodiments of the present invention, the coolant accommodates a spectrum of Newtonian coolants.

Furthermore, in accordance to some embodiments of the present invention, the coolant is selected from emulsions or oils.

Furthermore, in accordance to some embodiments of the present invention, the coolant and the pressurized gas enter into the gas and liquid coolant (GLC) aeroforce device concurrently, the gas enters through a designated port located within a gas connector, said gas traverses through a passage culminating in its arrival at a central bore, while the coolant enters through a designated opening and passes through at least one passage and enters into a coolant radial slot, a pivotal axisymmetric region, and continues to a space where gas and liquid culminate in the creation of GLC.

Furthermore, in accordance to some embodiments of the present invention, the gas and liquid coolant (GLC) aeroforce device is connected to a dedicated pneumatic valve or a standard pneumatic valve to manage a synchronized delivery of gas and coolant, said dedicated pneumatic valve or a standard pneumatic valve halts gas pressure immediately when the coolant pressure stops to prevents unnecessary gas consumption and to avoid formation of clouds inside a machine, ensuring efficient operation.

Furthermore, in accordance to some embodiments of the present invention, a check valve is used to prevent coolant flow into the gas pressure system.

Furthermore, in accordance to some embodiments of the present invention, a control valve is used to allow for disconnecting the gas pressure supply when there is no coolant pressure, thus preventing gas flow without coolant and the formation of unnecessary coolant clouds.

### DETAILED DESCRIPTION OF THE INVENTION

The present invention introduces a groundbreaking innovation that addresses a crucial challenge in the domain of metalworking machines—the optimization of cooling, lubrication, and chip clearance processes within machining operations. This invention revolves around a meticulously designed aeroforce device that seamlessly integrates liquid pressure and gas pressure to create Gas Liquid Coolant (GLC). The GLC, in turn, revolutionizes machining efficiency, process optimization, and cutting tool longevity.

Metalworking machines heavily rely on efficient cooling and lubrication mechanisms to ensure precise machining, chip clearance, and prolonged cutting tool life. However, a recurring obstacle emerges when the existing coolant pressure within these machines is insufficient to meet these critical objectives. Traditional remedies have often involved the integration of larger, more potent coolant pumps, a solution that proves both costly and space consuming. Within the domain of metalworking machines, the imperative of effectively cooling and lubricating the processing point using a coolant resonates as a cornerstone for process optimization, expeditious chip clearance, and the elongation of the machining cutting tool's operational lifespan. However, a recurring challenge arises when many metal processing machines lack the requisite coolant pressure to fulfill these critical functions efficiently. This deficiency often leads to suboptimal performance, increased wear on machining tools, and frequent maintenance requirements. In such scenarios, the integration of a gas and liquid coolant (GLC) aeroforce device emerges as a prospective remedy, offering a transformative solution to these persistent issues. The gas and liquid coolant (GLC) aeroforce device is meticulously designed to generate a precise mixture of liquid and gas coolant (GLC) by leveraging gas (air) and liquid (oil, emulsion) pressure, ensuring optimal cooling and lubrication.

The approach of the present invention not only significantly enhances the overall performance of the machine but also obviates the need for a complex and costly coolant pump. By simplifying the coolant delivery system, the gas and liquid coolant (GLC) aeroforce device reduces maintenance costs and downtime, contributing to improved operational efficiency and sustainability.

The inventive framework detailed in the present application encompasses a novel device for seamlessly integrating gas pressure into existing coolant transportation systems. This integration is poised to revolutionize metalworking processes by ensuring consistent coolant flow and pressure, thereby optimizing machining operations.

The present invention is of a gas and liquid coolant (GLC) aeroforce device. The integration of a gas and liquid coolant (GLC) aeroforce device into a cooling and lubrication system emerges as a viable solution. The core function of the gas and liquid coolant (GLC) aeroforce device centers around the generation of Gas Liquid Coolant (GLC).

Gas liquid coolant refers to the process of mixing gas such as air with a liquid coolant using gas and liquid pressure to create a stable, homogeneous mixture.

In the context of metalworking machines, this technique ensures that the coolant is effectively aerated, enhancing its cooling and lubricating properties.

The gas pressure facilitates the creation of high-speed coolant flow, resulting in improved coverage and thermal management at the machining interface, which leads to better performance and longevity of the cutting tools and workpieces.

Furthermore, the gas and liquid coolant (GLC) aeroforce device aids in the efficient clearance of chips and swarf from the machining area, preventing chip buildup that could otherwise impede the machining process.

The pivotal advantage of the gas and liquid coolant (GLC) aeroforce device lies in its ability to augment machine performance without necessitating the implementation of a bulky and expensive coolant pump. By capitalizing on gas pressure to create GLC, the gas and liquid coolant (GLC) aeroforce device operates with a reduced infrastructure footprint, making it an economical and space-efficient alternative. This breakthrough concept paves the way for enhanced operational efficiency and reduced overhead costs.

The innovative framework elucidated in this invention is designed to seamlessly integrate the gas and liquid coolant (GLC) aeroforce device into existing coolant transportation piping infrastructure. This integration not only simplifies the adoption of GLC technology into metal processing machines but also preserves the continuity of established coolant delivery systems.

The gas and liquid coolant (GLC) aeroforce device of the present invention offers a highly efficient and versatile solution to optimize the machining process, without the need for large and costly coolant pumps. The present invention is marked by its seamless integration into existing coolant transportation piping, ensuring continuity with established systems while vastly enhancing operational efficiency.

In accordance with some embodiments of the present invention, the various components of the gas and liquid coolant (GLC) aeroforce device may be made from metals and/or alloys, such as for instance, aluminum, steel, stainless-steel and the like.

In accordance with some embodiments of the present invention, when gas and liquid are introduced into the gas and liquid coolant (GLC) aeroforce device of the present invention and the GLC mixture is extracted from the exit port, several physical phenomena occur:
Intermolecular Interactions: The gas and liquid molecules interact, leading to the formation of the GLC mixture. These interactions can cause changes in pressure and temperature within the aeroforce meeting point. The initial pressure of the gas and liquid in the gas and liquid coolant (GLC) aeroforce device creates a force that drives the mixture out through the exit port. According to Pascal's principle, the pressure applied to a confined fluid is transmitted equally in all directions. As the mixture exists from the gas and liquid coolant (GLC) aeroforce device it undergoes a rapid change in velocity. Bernoulli's principle states that an increase in the speed of a fluid occurs simultaneously with a decrease in pressure or potential energy of the fluid. This principle helps explain why the flow velocity at the exit is high. If the pressure within the aeroforce drops below the vapor pressure of the liquid, cavitation can occur. This involves the formation of vapor bubbles within the liquid, which can collapse and create high-velocity jets.
Energy Conversion: The energy stored in the compressed gas is converted into kinetic energy as the GLC mixture exits the gas and liquid coolant (GLC) aeroforce device. This conversion is more efficient due to the compressibility of gas, leading to higher exit velocities and greater momentum.
A higher gas-to-liquid ratio can increase exit velocity due to the gas's ability to expand rapidly. In practical applications, the optimal ratio is often determined experimentally. In accordance with some embodiments of the present invention, end users may adjust the gas-to-liquid ratio in the gas and liquid coolant (GLC) aeroforce device and measure the resulting exit velocities and momentum (stagnation force) to find the most efficient combination. While there is no one-size-fits-all ratio, a higher proportion of gas relative to liquid generally helps to achieve higher exit velocities due to the efficient energy conversion from the compressible gas. The exact ratio should be determined based on the specific system, gas and liquid properties.
In high-velocity systems as the gas and liquid coolant (GLC) aeroforce device, the processes occur so quickly that there is minimal time for heat exchange with the environment. This rapidity means that the system can be considered adiabatic, where no heat is transferred to or from the surroundings. An adiabatic process is one where there is no heat transfer (Q=0). In practical terms, if the process is fast enough, the heat exchange with the environment is negligible, making the adiabatic approximation valid. In such systems, the energy is primarily converted between kinetic and potential forms rather than being lost as heat. When the gas and liquid mixture expands from high to low pressure, it undergoes adiabatic expansion, meaning it expands without exchanging heat with the environment. During this process, the internal energy of the gas decreases, leading to a drop in temperature, which helps reduce the metal cutting temperature. For gases, the Joule-Thomson effect describes how a gas cools when it expands if it is initially at a temperature above its inversion temperature. As the gas expands and its pressure drops, its temperature also decreases.
As the pressure drops, some of the liquid may vaporize, absorbing heat from the remaining liquid and gas. This phase change requires energy, which is taken from the thermal energy of the mixture, resulting in a lower exit temperature.
At the interface where the gas meets the liquid, surface tension plays a significant role. Surface tension is the force that causes the surface of a liquid to behave like a stretched elastic membrane. This tension can create a barrier that resists the mixing of gas and liquid. When the liquid meets the gas perpendicularly, there is a transfer of momentum from the gas to the liquid. This can cause the liquid to accelerate and form jets or sprays. The high-speed gas flow can impart significant kinetic energy to the liquid, leading to high-velocity ejection of liquid.
The interaction between the high-speed gas and the liquid can create turbulent flow and cavitation. Cavitation occurs when the pressure in the liquid drops below its vapor pressure, leading to the formation of vapor bubbles. These bubbles can collapse violently, creating shock waves and further mixing the liquid and gas. The gas pressure is transmitted through the liquid. Since liquids are nearly incompressible, the pressure applied by the gas is distributed throughout the liquid almost uniformly.
At the interface where the gas meets the liquid, a boundary layer forms. This layer is where the velocity of the gas transitions to the velocity of the liquid. The interaction within this boundary layer can lead to complex flow patterns and turbulence.
Thus, when a large amount of liquid meets gas pressure perpendicularly, the primary effects are pressure transmission, surface deformation, momentum transfer, boundary layer interactions, and potential temperature changes. These phenomena are crucial in aeroforce performances.

Benefits and Advantages: The invention's merits are manifold. By harnessing gas pressure for mixture, the gas and liquid coolant (GLC) aeroforce device significantly enhances machining efficiency, cooling, lubrication, and chip clearance. Its ingenious design allows for the creation of GLC under diverse working pressures, rendering it adaptable to various operational contexts. The compact footprint of the gas and liquid coolant (GLC) aeroforce device, coupled with its integration into existing coolant transportation piping, ensures cost-effectiveness and minimal disruption to established setups.

### BRIEF DESCRIPTION OF THE FIGURES

FIG. 1 is a rear isometric view and FIG. 2 is a front isometric view of the gas and liquid coolant (GLC) aeroforce device in accordance with some embodiments of the present invention.

FIG. 3 is a front view of the gas and liquid coolant (GLC) aeroforce device in accordance with some embodiments of the present invention.

FIG. 4 is a top view of the gas and liquid coolant (GLC) aeroforce device in accordance with some embodiments of the present invention.

FIG. 5 is a rear view of the gas and liquid coolant (GLC) aeroforce device in accordance with some embodiments of the present invention.

FIG. 6 is a cross-sectional view A-A of the top view of the gas and liquid coolant (GLC) aeroforce device seen in FIG. 7 in accordance with some embodiments of the present application.

FIG. 7 is a top view of the gas and liquid coolant (GLC) aeroforce device in accordance with some embodiments of the present application.

FIG. 8 is a comprehensive side view of the gas and liquid coolant (GLC) aeroforce device in accordance with some embodiments of the present invention.

FIG. 9 is a cross-sectional view of the gas and liquid coolant (GLC) aeroforce device in accordance with some embodiments of the present invention.

FIG. 10 is a side view of the gas and liquid coolant (GLC) aeroforce device in accordance with some embodiments of the present invention.

FIG. 11 is a cross-sectional view, (DD) section of the gas and liquid coolant (GLC) aeroforce device in accordance with some embodiments of the present invention.

FIGS. 12-14 are isometric images of gas pressure introduction component.

FIGS. 15 and 16 are cross-sectional, AA section, views of the gas and liquid coolant (GLC) aeroforce device in accordance with some embodiments of the present invention.

FIG. 17 is a magnified view of section B in FIG. 16.

FIG. 18 depicts the area of transitions, both hydraulic and pneumatic, showing how the gas pressure (air) and the coolant are blended optimally.

FIGS. 19-23 illustrate an alternative gas and liquid coolant (GLC) aeroforce device in accordance with some embodiments of the present invention.

FIG. 24 is a schematic diagram of a system comprised of the gas and liquid coolant (GLC) aeroforce device connected via a dedicated pneumatic valve in accordance with some embodiments of the present invention.

FIG. 25 is a schematic diagram of a system comprised of the gas and liquid coolant (GLC) aeroforce device connected via a standard pneumatic valve in accordance with some embodiments of the present invention.

FIG. 26 is a detailed graph showing the stagnation force exerted by the coolant at the exit of the nozzle.

FIG. 27A illustrates the gas and liquid coolant (GLC) aeroforce device 1, 2 of the present invention, integrated in a process line.

FIGS. 27B-C illustrate a piece of metal before and after machining using the gas and liquid coolant (GLC) aeroforce device 1, 2 of the present invention.

FIG. 28A is a bottom view of a gas and liquid coolant (GLC) aeroforce device in accordance with some embodiments of the present invention, illustrating a moderate inlet configured for introducing liquid coolant and a rear inlet configured for introducing pressurized gas.

FIG. 28B is a cross-sectional view (section A-A) of the gas and liquid coolant (GLC) aeroforce device shown in FIG. 28A, illustrating an internal interface between the pressurized gas and the liquid coolant defined by a gradual, non-acute interaction angle, configured to induce a suction effect on the liquid coolant.

### DETAILED DESCRIPTION OF THE FIGURES

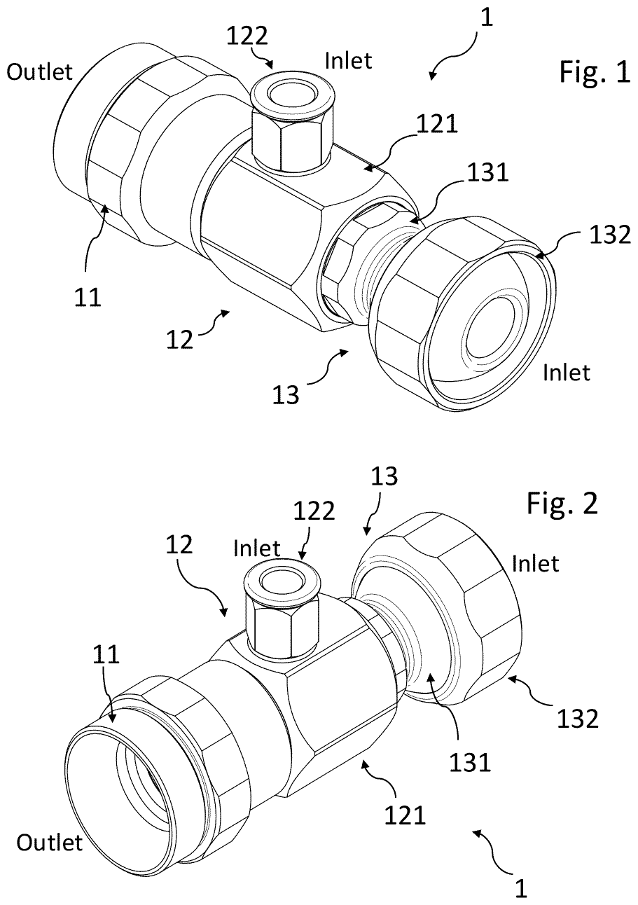

FIG. 1 is a rear isometric view and FIG. 2 is a front isometric view of the gas and liquid coolant (GLC) aeroforce device 1 in accordance with some embodiments of the present invention.

The gas and liquid coolant (GLC) aeroforce device 1 comprises three key components, denoted as GLC exit component 11, pressurized gas introduction component 12, and coolant introduction component 13, collectively contributing to a harmonized and efficient GLC process.

In accordance with some embodiments of the present invention, the GLC exit component 11 signifies the ultimate destination for the GLC process—the GLC process takes place within the GLC exit component 11 from which the GLC mixture exits ready for deployment.

The GLC, a delicate balance of coolant and pressurized gas, is carefully channeled through the GLC exit component 11, poised for strategic deployment within the machining environment.

In accordance with some embodiments of the present invention, in the GLC exit component 11 area 1101 the liquid integrates with the pressurized gas to create a high-pressure coolant.

In accordance with some embodiments of the present invention, the gas pressure introduction component 12 has a pivotal role in introducing the essential pressurized gas required for the GLC process. The optimal fusion of the pressurized gas with the coolant is achieved through the synergistic interaction between the pressurized gas and the coolant in the GLC exit component 11.

This collaborative mechanism guarantees the precise and effective amalgamation of the liquid coolant and gas, thereby setting the stage for GLC process.

Notably, gas is directed into the gas and liquid coolant (GLC) aeroforce device 1 through a dedicated connector, denoted as connector 122 situated within the pressurized gas introduction component 12.

In accordance with some embodiments of the present invention, the pressurized gas introduction component 12 may be adjacent to the coolant introduction component 13.

In accordance with some embodiments of the present invention, the coolant introduction component 13 may be at the core of the gas and liquid coolant (GLC) aeroforce device 1.

The coolant introduction component 13 is responsible for introducing the coolant substance into the GLC process. The coolant introduction component 13 serves as the initial point of entry for the coolant, orchestrating its integration into the gas and liquid coolant (GLC) aeroforce device 1.

This dynamic interaction initiates the GLC process, laying the groundwork for enhanced cooling, lubrication, and chip clearance.

The coolant introduction component 13 may comprise two integral subcomponents, namely the outlet ball connection 131 and the outlet nut connection 132, which collectively facilitate seamless integration with the existing coolant transportation pipeline. The Liquid pressure can be connected by many other means such as: screwing, welding, adhesive bonding or any other connection means.

The coolant introduction component 13 acts as the conduit for introducing the liquid coolant into the GLC process.

The outlet ball connection 131 takes the form of a ball connector, ingeniously designed to establish a robust and secure connection between the coolant introduction component and a transportation pipeline ensuring a reliable flow of coolant. Meanwhile, the outlet nut connection 132, a nut-like element, plays a complementary role by enabling the secure locking of the spherical connector, bolstering the stability and integrity of the coolant introduction mechanism.

In accordance with some embodiments of the present invention, the orchestration of the gas and liquid coolant (GLC) aeroforce device 1 involves a meticulously choreographed interplay between these three core components—the coolant introduction component 13, the gas pressure introduction component 12, and the GLC exit component 11 resulting in a highly effective and efficient GLC process.

Through this geometric ingenuity, the gas and liquid coolant (GLC) aeroforce device 1 achieves a remarkable fusion of liquid pressure and gas pressure, facilitating the creation of GLC across a spectrum of operational pressures.

In accordance with some embodiments of the present invention, the gas and liquid coolant (GLC) aeroforce device 1 allows the utilization of a wide range of gases such as air, nitrogen, oxygen and the like. Similarly, the gas and liquid coolant (GLC) aeroforce device 1 may accommodate a spectrum of Newtonian coolants, including but not limited to emulsions and oils.

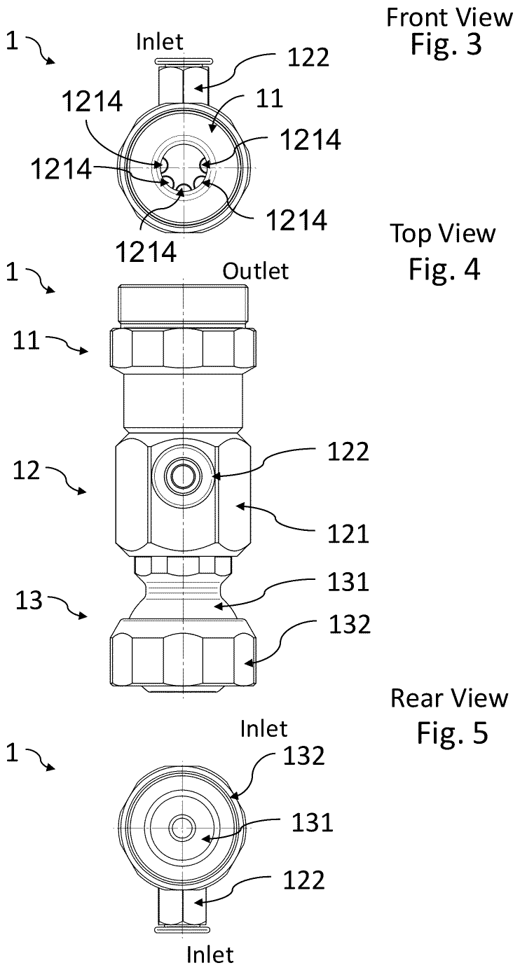

FIG. 3 is a front view of the gas and liquid coolant (GLC) aeroforce device 1 in accordance with some embodiments of the present invention.

In accordance with some embodiments of the present invention, a key highlight of FIG. 3 is the meticulous arrangement of multiple passages, such as, for instance, axial coolant bores 1214. These passages, axial coolant bores, 1214 are strategically designed to facilitate the seamless flow of liquid from the entry point towards the critical juncture of integration with pressurized gas.

In accordance with some embodiments of the present invention, the gas and liquid coolant (GLC) aeroforce device 1 may comprise at least one passage to facilitate the seamless flow of liquid from the entry point towards the critical juncture of integration with pressurized gas. Notably, this entrance serves as the juncture where the coolant is introduced into the system, commencing its transformative journey towards becoming GLC.

Seen in the figure are gas inlet 122 and axial coolant bores 1214 which are liquid integration and gas pressure conduits.

A mechanical design decision is evidenced by the presence of 5 passages, axial coolant bores 1214 with the upper region near the gas inlet 122 exclusively reserved for the conveyance of gas. This deliberate allocation, enabling the careful integration of liquid coolant and gas pressure to achieve low volume configuration.

It should be noted that FIG. 3 illustrates 5 passages, axial coolant bores, 1214. However, in accordance with some embodiments of the present invention, the number of passages may vary. FIG. 4 is a top view of the gas and liquid coolant (GLC) aeroforce device 1 in accordance with some embodiments of the present invention.

FIG. 4 offers an illuminating top perspective of the gas and liquid coolant (GLC) aeroforce device 1, providing a comprehensive overview of the geometrical arrangement and component relationships. FIG. 4 highlights the strategic positioning of the components, reaffirming their interdependence and the orchestrated flow of liquid and pressurized gas.

The top view of the gas and liquid coolant (GLC) aeroforce device 1 encapsulates the spatial integrity of the design, showcasing the synergy between the components in facilitating the GLC process.

FIG. 5 is a rear view of the gas and liquid coolant (GLC) aeroforce device 1 in accordance with some embodiments of the present invention.

FIG. 5 casts the spotlight on the exit point 1101 of the GLC process—the culminating point of the GLC journey. The exit opening, carefully engineered within the system, signifies the transformation of the integrated liquid and gas pressure into a GLC mixture. This exit point not only underscores the successful realization of GLC but also heralds the readiness of the GLC for effective deployment within the machining environment.

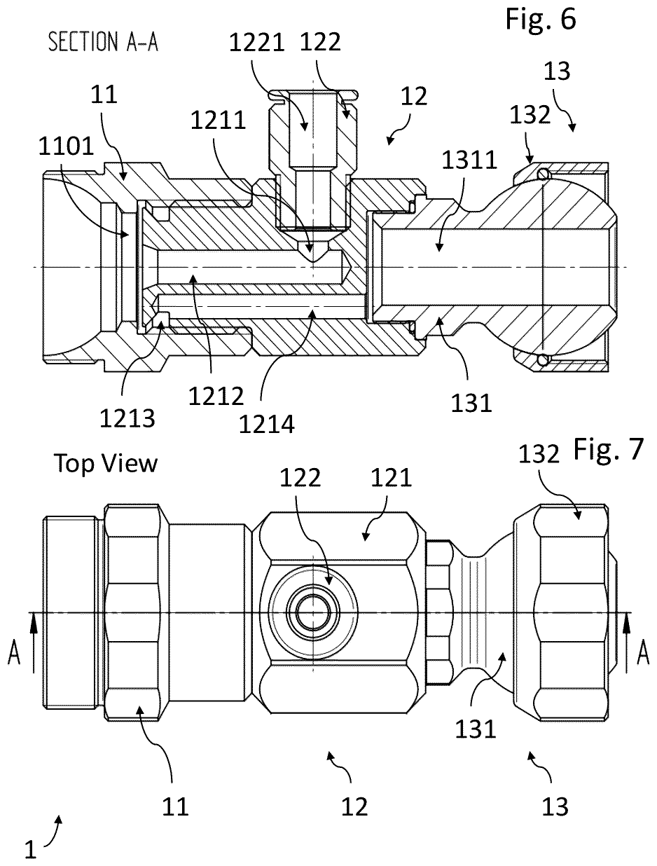

FIG. 6 is a cross-sectional view A-A of the top view of the gas and liquid coolant (GLC) aeroforce device 1 seen in FIG. 7 in accordance with some embodiments of the present application.

FIG. 6 presents a cross-sectional view of the system, illuminating the nature of fluid passages and their intricate interaction. seen in the figure are the following components of the aeroforce device 1: inlet liquid connection 13, inlet ball connection 132, inlet gas connection 122, outlet GLC connection 11, gas axial bore 1212, liquid axial bores 1214, coolant radial slot and outlet area 110.

In accordance with some embodiments of the present invention, pressurized gas enters through the gas connector's designated port, denoted as 1221. The gas then courses through passage 1211, seamlessly reaching the central bore 1212. Simultaneously, liquid coolant is introduced through opening 1311, interfacing with part 121, and subsequently being transferred to passages 1214.

The cross-sectional view A-A delves into the intricate mechanics of the gas and liquid coolant (GLC) aeroforce device 1, shedding light on the internal workings that orchestrate the atomization process. Particularly, this view illuminates the pathways of both liquid and gas passages as they traverse through connector 121.

FIG. 6 offers a revealing perspective on the integration of liquid and gas passages within connector 121. Notably, within this section, a solitary liquid passage, denoted as 1214, becomes evident. This configuration is a calculated design choice, as the upper and central portions are dedicated to the effective conveyance of gas-a pivotal component in the GLC process. This deliberate separation ensures the precision of gas and liquid flow, a cornerstone for achieving efficient GLC.

The cross-sectional view A-A of the top view of the gas and liquid coolant (GLC) aeroforce device 1 also elucidates the vital connection between connector 121 and the GLC exit component 11, serving as the epicenter for GLC production. The intricate interplay between these components forms the crux of the GLC process. The coupling between connector 121 and the GLC exit component 11 harmonizes the liquid and the pressurized gas to generate GLC poised for deployment due to the formation of radial slot 1213 as liquid jet.

Adjacent to the core components, gas inlet 122 emerges as a gas connector-a conduit through which pressurized gas is routed. Within gas inner 122 lies the gas transport bore, denoted as 1221, which serves as the pathway for the passage of gas pressure. The design of gas inlet 122 emphasizes the seamless integration of pressurized gas into the GLC process. Within connector 121, a key passage denoted as radial gas bore in the base 1211 facilitates the seamless transfer of gas from the connector 121 to the central bore 1212. This interaction is pivotal in channeling pressurized gas to the central area where GLC process takes place. A noteworthy highlight within this view is Area 1101, GLC process zone, demarcating the zone where the GLC process transpires. It is within this designated area that the integration of liquid and pressurized gas culminates, resulting in the creation of GLC.

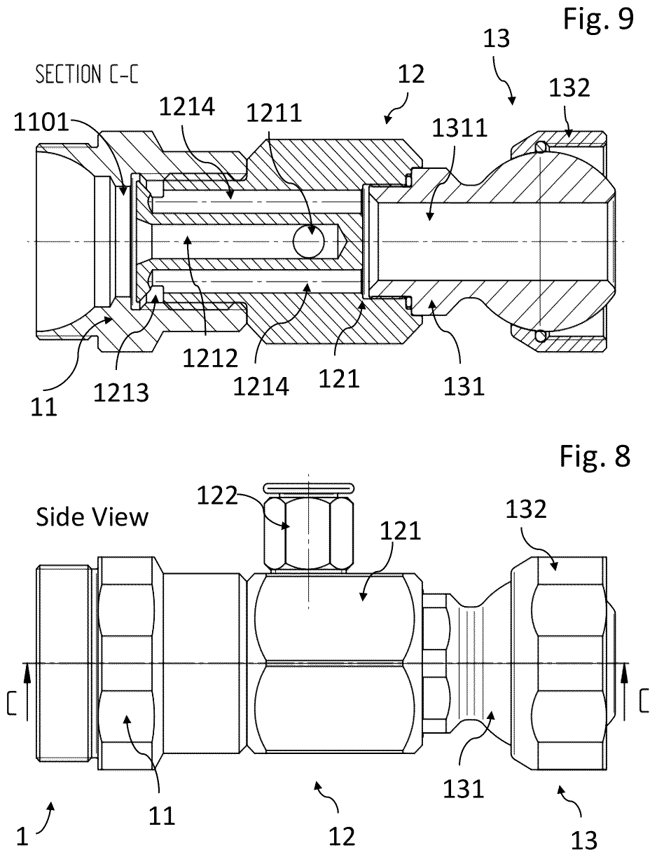

FIG. 8 is a comprehensive side view of the gas and liquid coolant (GLC) aeroforce device 1 in accordance with some embodiments of the present invention.

In accordance with some embodiments of the present invention, FIG. 8 offers a different perspective on the configuration of the gas and liquid coolant (GLC) aeroforce device 1. Notably, this side view serves as a precursor to the creation of a crucial cross-sectional (CC) section—a perspective that can be explored in greater detail through FIG. 9.

FIG. 9 is a cross-sectional view of the gas and liquid coolant (GLC) aeroforce device 1 in accordance with some embodiments of the present invention.

FIG. 9 provides a comprehensive overview of the components of the gas and liquid coolant (GLC) aeroforce device 1. The unique contribution of FIG. 9 lies in the detailed cross-sectional (CC) section it offers. This section is an invaluable tool in understanding the intricate inner workings of the system, shedding light on critical aspects that drive the atomization process. Within the context of the CC section in FIG. 9, a pivotal insight emerges: the presence of two fluid passages denoted as axial coolant bores 1214. These passages, hitherto observed, are central to facilitating the passage of liquid, ensuring its effective integration within the GLC process. Simultaneously, this CC section exposes a passage dedicated to channeling gas-specifically, passage 1211—into the central region. The convergence of these passages within the CC section underscores the focus of the present invention on achieving a harmonious and precise interaction between liquid and gas pressure.

The delineation of these fluid passages within the CC section is instrumental in illuminating the core mechanics of the GLC process. The presence of two fluid passages, axial coolant bores 1214—designated for liquid—augments the dedication of the present invention to achieving efficient coolant distribution. Similarly, the gas passage 1211 further solidifies the commitment of the present invention to integrating pressurized gas with precision to catalyze the GLC process.

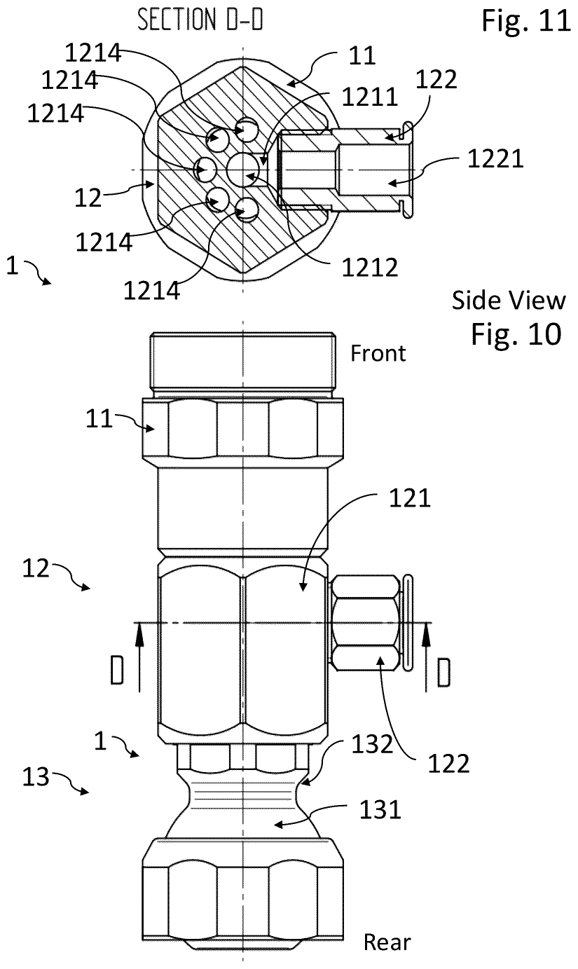

FIG. 10 is a side view of the gas and liquid coolant (GLC) aeroforce device 1 in accordance with some embodiments of the present invention.

The figure offers an encompassing view of the components of the gas and liquid coolant (GLC) aeroforce device 1, mirroring the components observed in the previous figures. However, the profound contribution of FIG. 10 is the comprehensive cross-sectional (DD) section it provides as seen in FIG. 11. This section is instrumental in unraveling the intricate inner workings of the gas and liquid coolant (GLC) aeroforce device 1, shedding light on critical aspects that shape the GLC process.

FIG. 11 is a cross-sectional view, (DD) section of the gas and liquid coolant (GLC) aeroforce device 1 in accordance with some embodiments of the present invention.

The cross-sectional view, (DD) section of the gas and liquid coolant (GLC) aeroforce device 1 is created from the side view of FIG. 10.

Seen in the figure are fluid passages, axial coolant bores 1214. These passages, fundamental in guiding the flow of liquid coolant, converge in this comprehensive cross-sectional perspective, offering a consolidated insight into their strategic arrangement. Moreover, the section vividly presents the central gas passage, designated as 1211, which holds the key to facilitating the entry of pressurized gas into the heart of the gas and liquid coolant (GLC) aeroforce device 1.

The strategic emphasis on depicting this specific part arises from its central and paramount role within the gas and liquid coolant (GLC) aeroforce device 1. Component 121 serves as a critical nexus facilitating the entry of gas, the introduction of liquid, and the interface between gas and liquid—operations that culminate in the creation of GLC process.

The elevated importance of the pressurized gas introduction component 12 is underscored by its strategic position as a fulcrum of functionalities within the gas and liquid coolant (GLC) aeroforce device 1. The depiction of the pressurized gas introduction component 122 in these figures is an acknowledgment of its pivotal role in orchestrating a seamless synergy between pressurized gas, liquid coolant, and the GLC process's finale. This central role marks pivotal component 121 as an engine of transformative change within the system's mechanics.

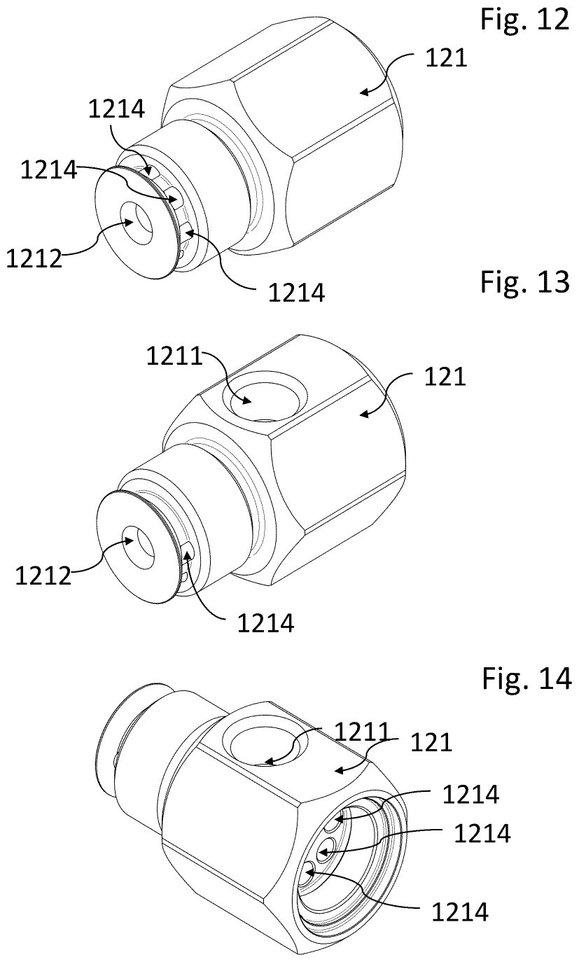

A salient feature of component 121 becomes particularly apparent in FIGS. 12 and 13 the presence of a distinctive sharp edge element 1215. This element, precisely located at the exit points of the designated passages, axial coolant bores 1214, plays a transformative role in altering the movement dynamics of the liquid coolant. As the liquid emerges from the passages, axial coolant bores 1214, the sharp edge element 1215 serves as a catalyst in redirecting the liquid's movement from its initial axial flow direction to a radial trajectory directed toward the center of pivotal component 121.

In accordance with some embodiments of the present invention, the transition from axial to radial movement is a key juncture where the interface between gas and liquid is facilitated. As the liquid converges toward the center of pivotal component 121, it interfaces with the introduced pressurized gas. This interfacing, further augmented by the design of the sharp edge element 1215, forms the crux of the GLC process. The liquid-gas interface is transformed into GLC, poised for deployment within the machining environment.

In accordance with some embodiments of the present invention, a pivotal aspect of the GLC process unfolds as the liquid coolant converges toward the center of Part 121. Here, a sharp edge element 1215 conspicuously captured in FIGS. 12 and 13 reorients the liquid's trajectory from axial flow to a radial movement directed toward the center of the part. This orchestrated transition, facilitated by the sharp edge element 1215, marks the interface point between gas and liquid—a juncture crucial for successful GLC process.

As liquid converges within the coolant radial slot 1213, the GLC process is catalyzed. The integration of these two components, gas and liquid in this axisymmetric space lays the foundation for the transformation into GLC. This convergence continues within space 1101, where the GLC fully takes form, fusing liquid and gas pressure into a mixture poised for deployment.

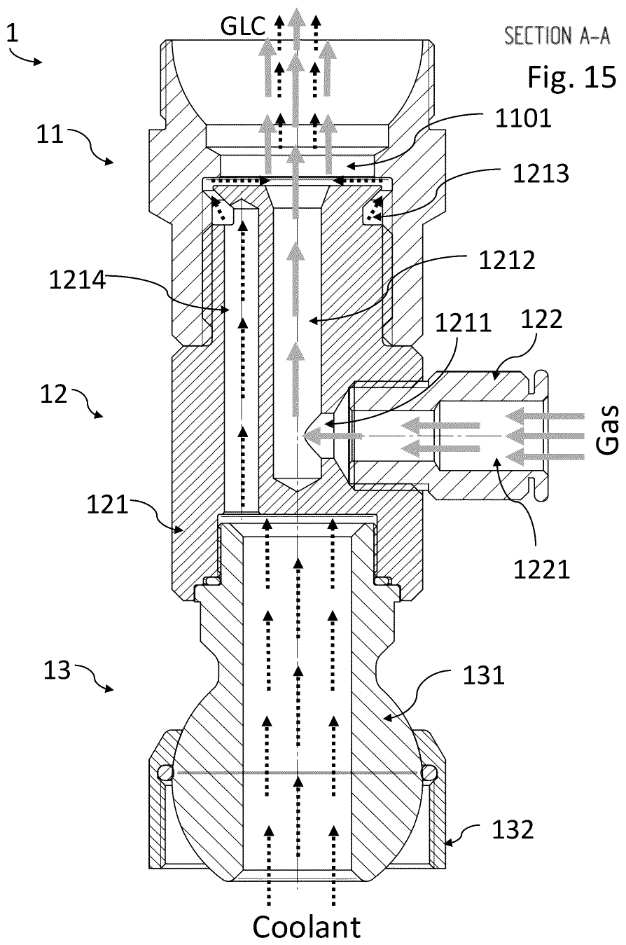

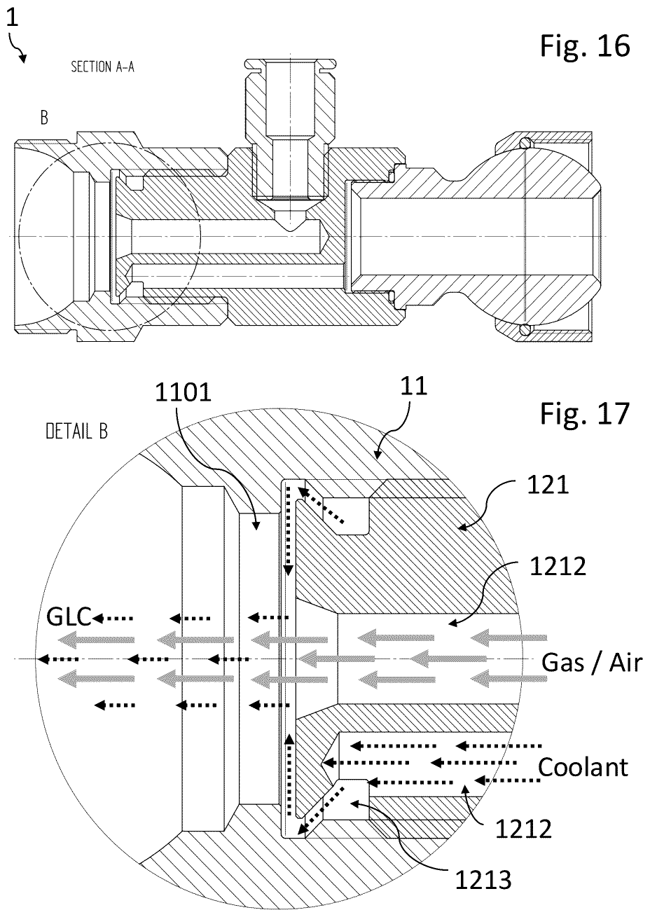

FIGS. 15 and 16 are cross-sectional, AA section, views of the gas and liquid coolant (GLC) aeroforce device 1 in accordance with some embodiments of the present invention.

FIGS. 15 and 16 are harnessed in tandem to illustrate a crucial cross-sectional perspective, unveiling the intricate nature of coolant and gas flow leading to their confluence and the subsequent creation of GLC. The concerted use of these figures provides a visual narrative that unravels the mechanics behind the transformative process of the invention.

Complementary to the foregoing figures, FIG. 16 furnishes an insightful cross-sectional view represented by Section AA, which subsequently serves as the basis for the derivation of section B—a granular exploration of specific mechanics. This cross-sectional section illuminates the inner workings of the gas and liquid coolant (GLC) aeroforce device 1, bringing to the fore the dynamic interactions of gas and coolant leading to GLC generation.

FIG. 17 is a magnified view of section B in FIG. 1. The figure provides a pivotal insight into the intricate fluid dynamics at play within the gas and liquid coolant (GLC) aeroforce device 1. The depiction elucidates the journey of gas, which enters through the designated port 1221, located within gas connector 122. This incoming gas traverses through the passage 1211, culminating in its arrival at the central bore 1212. This meticulously orchestrated journey of gas underscores the emphasis of the invention on precision and effectiveness in integrating gas pressure within the gas and liquid coolant (GLC) aeroforce device 1.

Concurrently, the coolant's ingress into the gas and liquid coolant (GLC) aeroforce device 1 is portrayed in detail within FIG. 17. The coolant enters through the designated opening 1311, a crucial aspect of part 131.

Through an intricate interface mechanism, the liquid coolant seamlessly interfaces with part 121, resulting in its transfer to five passages designated as 1214. This strategic arrangement ensures the controlled and precise distribution of liquid coolant a central aspect in achieving efficient GLC.

FIGS. 15 and 17 unveil a pivotal juncture within the system's dynamics: the convergence of gas and liquid coolant. This amalgamation transpires within coolant radial slot 1213, a pivotal axisymmetric region that catalyzes the transformation of the introduced elements into GLC.

As the liquid proceeds from coolant radial slot 1213 to space 1101, the two constituents gas and liquid culminate in the creation of GLC. This transformation marks the zenith of the GLC process, setting the stage for efficient cooling, lubrication, and chip clearance.

The collective information conveyed through FIGS. 15 and 17, encapsulates a comprehensive understanding of the fluid dynamics within the gas and liquid coolant (GLC) aeroforce device 1. This intricately orchestrated flow, involving the seamless integration of gas and liquid, serves as the bedrock for the patent's revolutionary GLC process. The innovative configuration of the invention, brought to life through these illustrations, symbolizes a pivotal shift in the realm of cooling, lubrication, and chip clearance processes within metalworking machines, ushering in a new era of precision, productivity, and tool longevity.

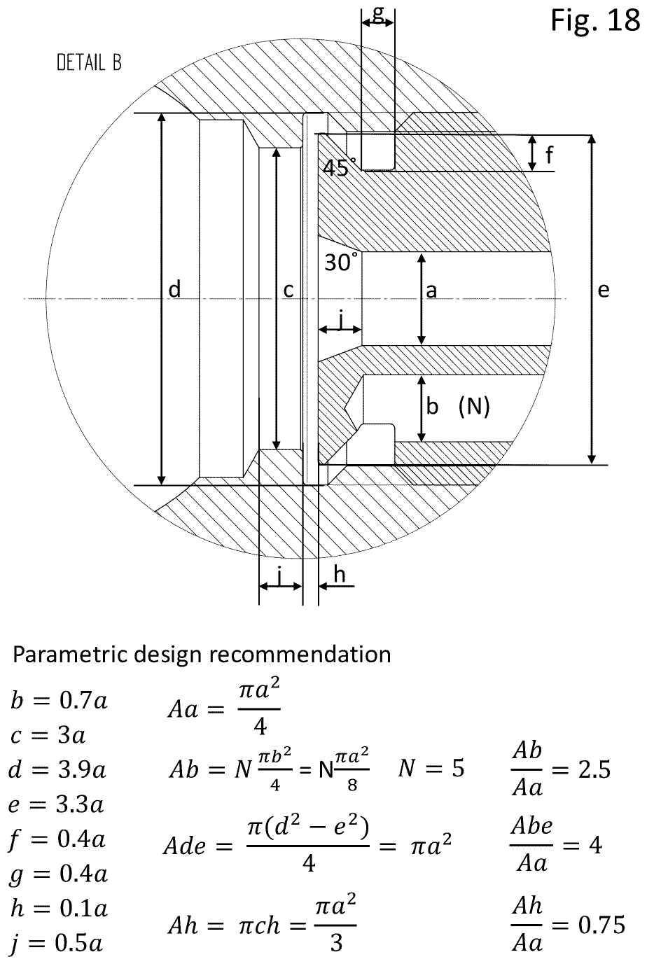

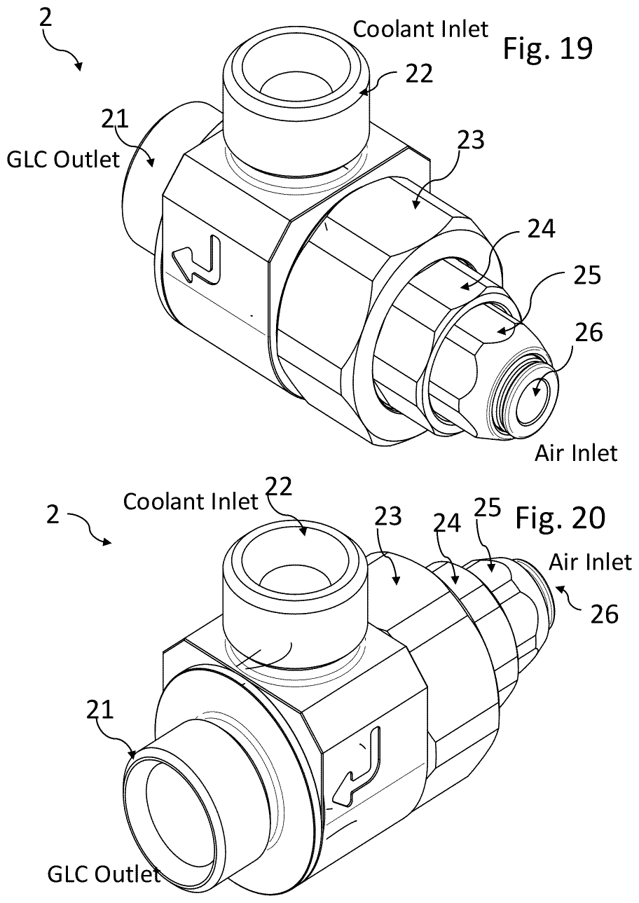

FIG. 18 is a magnified view of section B of FIG. 16 including parametric calculations.

FIG. 18 depicts the area of transitions 1212, 1213, 1214, 1215, 1011 both hydraulic and pneumatic, showing how the pressured gas and the coolant are blended optimally. This figure illustrates parametric distances that facilitate practical mechanical design of the gas and liquid coolant (GLC) aeroforce device 1. It is important to note that these are general guidelines, and further optimization must be carried out following the mechanical design.

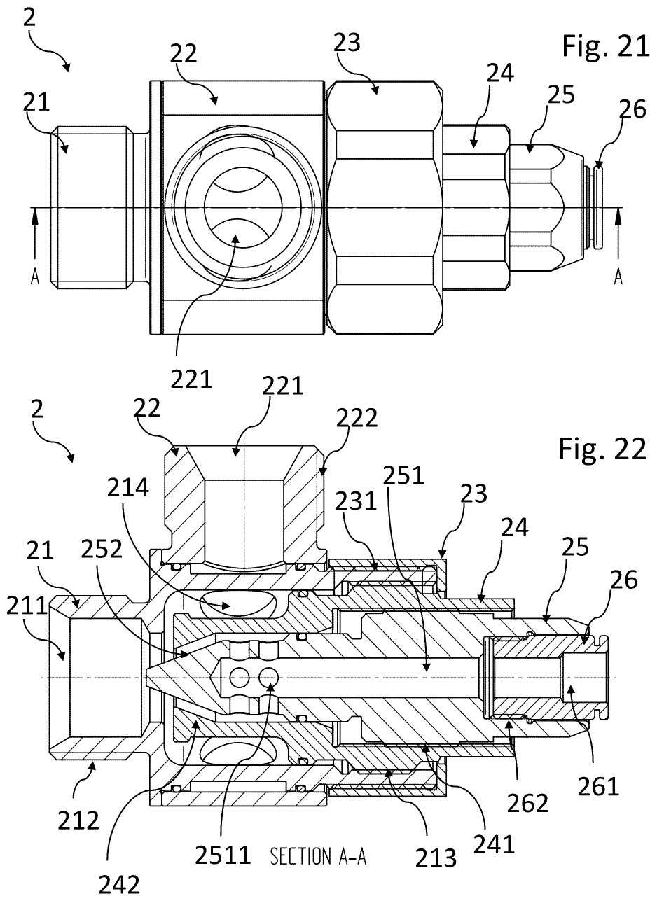

FIGS. 19-23 illustrate an alternative gas and liquid coolant (GLC) aeroforce device 2 in accordance with some embodiments of the present invention.

Ther alternative gas and liquid coolant (GLC) aeroforce device 2 may include a mechanism adjusting flow rates and pressures, wherein the throttles at the terminal points of the coolant and gas flows are configured to be adjusted through the use of screws or any equivalent means. Such adjustments ensure that the connection point between the coolant and gas flows is optimized based on the specific infrastructure of each machine.

Thus, in accordance with some embodiments of the present invention, the alternative gas and liquid coolant (GLC) aeroforce device 2 enables adjustment of the flow rates and pressures of both the cooling liquid and the gas through a set of screws, first screw 213, second screw 231 and third screw 241. These screws facilitate relative axial movement between first component 23, second component 24 and third component 25, thereby allowing for the narrowing of liquid passage 282 and gas passage 218.

By adjusting the passage dimensions, the gas and liquid coolant (GLC) aeroforce device 2 controls flow rates, pressures, and flow speeds. These adjustments directly impact the connection point between the coolant and gas, ensuring that the gas-liquid-coolant (GLC) mixture exits through the outlet 211 in an optimal manner. The adjustment process may be performed while visually inspecting the GLC at the final throttle's exit until the desired operational parameters are achieved.

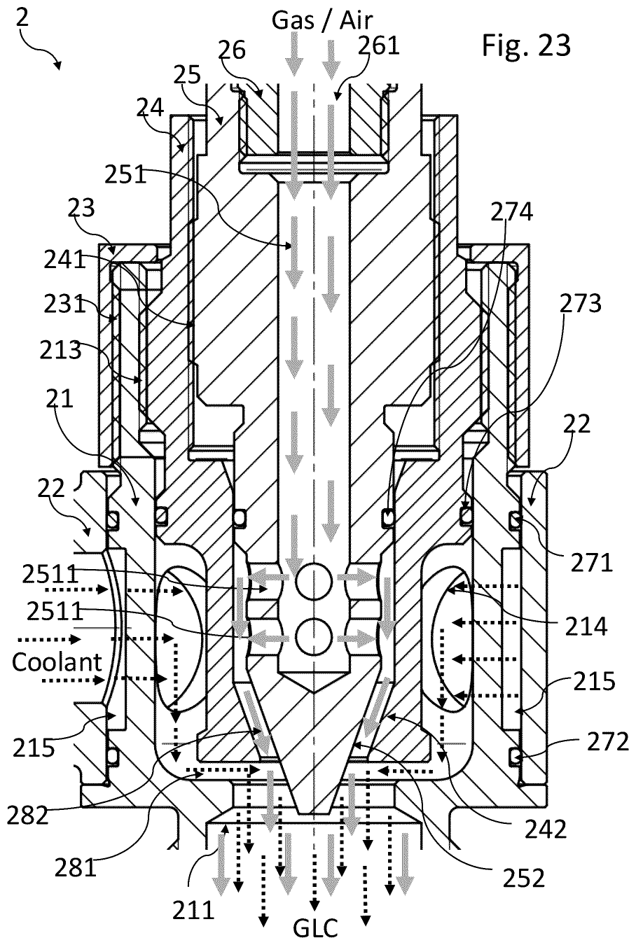

In reference to FIGS. 19 and 20, the gas and liquid coolant (GLC) aeroforce device 2 incorporates hexagonal elements in first static part 23, second rotating part 24, and third rotating part 25, which are accessible to the end user for system adjustment. Second rotating part 24 relative to first static part 23 allows for adjustment of the liquid pressure, while third rotating part 25 relative to second rotating part 24 adjusts the gas pressure. First static part 23 remains static in relation to the base of the gas and liquid coolant (GLC) aeroforce device 2. Furthermore, as depicted in FIGS. 22 and 23, the internal structure of the gas and liquid coolant (GLC) aeroforce device 2 shows the entry point for liquid pressure (221), the entry point for gas pressure 281, and the exit passages for the gas, liquid, and the gas-liquid-coolant (GLC) mixture.

The gas and liquid coolant (GLC) aeroforce device 2 further comprises multiple gaskets such as, for instance, first gasket 271, second gasket 272, third gasket 273 and forth gasket 274 positioned to seal the various components, thereby preventing premature mixing of the coolant and gas, as well as preventing unwanted coolant leakage. The outer cover 23 functions as a hexagonal base and also serves to prevent the unintentional release of part 24, which is used as a movement limiter within the gas and liquid coolant (GLC) aeroforce device 2.

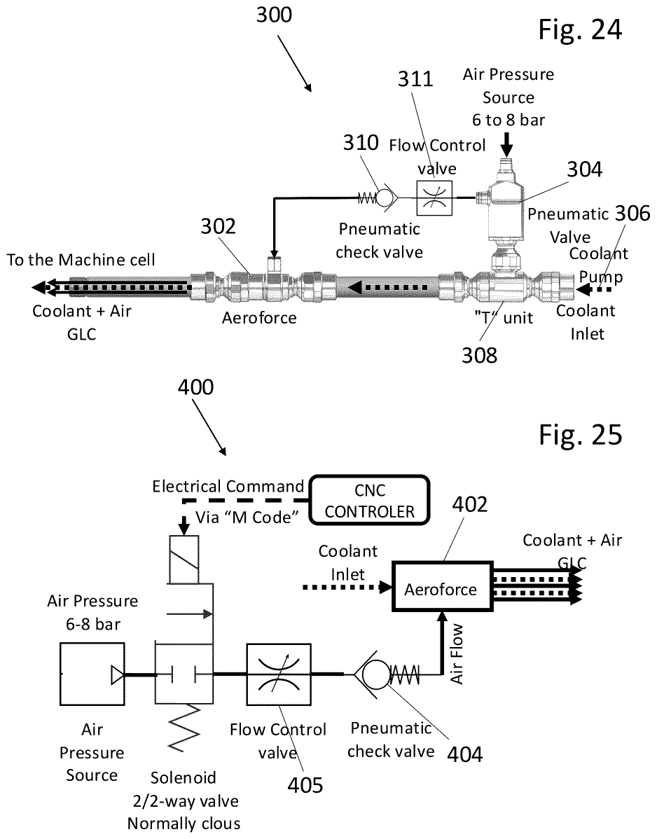

FIG. 24 is a schematic diagram of a system 300 comprised of the gas and liquid coolant (GLC) aeroforce device 302 connected to a dedicated pneumatic valve 304 in accordance with some embodiments of the present invention.

In accordance with some embodiments of the present invention, system 300 integrates the gas and liquid coolant (GLC) aeroforce device 302 with a dedicated pneumatic valve 304, designed to manage the synchronized delivery of gas and coolant pressure. The pneumatic valve 304 halts gas pressure immediately when coolant pressure stops. This prevents unnecessary gas consumption and avoids the formation of clouds inside the machine, ensuring efficient operation.

In accordance with some embodiments of the present invention, coolant is supplied from the machine's integral pump 306 and routed through a T-valve 308. The T-valve 308 plays a critical role by transferring coolant pressure to the pneumatic valve 304, commanding it to activate the gas pressure when needed.

A gas pressure regulator of the system 300 adjusts the gas flow and pressure, ensuring they match the coolant's pressure for optimal performance. The gas regulator is indispensable in achieving process optimization, as it ensures precise control over the gas pressure.

To protect the system 300 from potential reverse flow, a check valve 310 is integrated. This one-way valve prevents situations where higher coolant pressure might cause coolant to flow back into the gas pressure system. Such protection is crucial for maintaining system integrity and performance.

The coolant and gas pressures converge within the gas and liquid coolant (GLC) aeroforce device 302 accessory to form a combined gas-liquid coolant GLC mixture, which is then directed to the machine's cooling area for effective operation.

FIG. 25 is a schematic diagram of a system 400 comprised of the gas and liquid coolant (GLC) aeroforce device 402 connected via a standard pneumatic valve 404 in accordance with some embodiments of the present invention.

In accordance with some embodiments of the present invention, FIG. 25 employs an alternative standard pneumatic valve for controlling gas pressure in accordance with some embodiments of the present invention.

Unlike the dedicated pneumatic valve in 310 of FIG. 23, this configuration relies on electric commands from the machine's integral controller for starting and stopping gas pressure. This approach offers a simpler design but requires interfacing with the machine's control system and the creation of a custom procedure for seamless operation.

In accordance with some embodiments of the present invention, the system 400 includes a gas pressure regulator 405 to ensure that the gas flow and pressure are adjusted to align with the coolant pressure. This regulator remains a key component for optimizing the process and achieving the desired system performance. A check valve 406 is also present in this configuration, providing essential protection against reverse flow and safeguarding the gas pressure system from potential contamination by coolant under high pressure.

In both FIGS. 24 and 25, the coolant and gas pressures are combined within the gas and liquid coolant (GLC) aeroforce device 302, 402 to produce a gas-liquid coolant GLC mixture. This mixture is delivered to the required cutting zone in the machine, supporting efficient and precise cooling operations.

Both systems 300, 400 are designed to ensure reliable and synchronized delivery of gas and coolant pressure to the gas and liquid coolant (GLC) aeroforce device 302, 402.

System 300 emphasizes operational independence from the machine's controller, utilizing a dedicated pneumatic valve, while system 400 offers a more streamlined approach through electric commands from the machine's controller. Both systems 300, 400 include essential components such as the gas pressure regulator, and check valve to optimize performance and ensure system protection, providing flexibility for varying customer requirements and operational preferences.

The system further comprises a control valve 311 that allows for the disconnection of the gas pressure supply when there is no coolant pressure, thus preventing gas flow without coolant and the formation of unnecessary coolant clouds.

The following points should be noted in accordance with some embodiments of the present invention:
1. A gas regulator should be used, followed immediately by a check valve. The purpose of the gas regulator is to control the amount of gas entering the gas and liquid coolant (GLC) aeroforce device, while the check valve prevents coolant from flowing back into the gas system when the pressure difference is too high.
2. It is recommended to connect a control valve, which can be either mechanical or pneumatic. This control valve allows for the disconnection of the gas pressure supply when there is no coolant pressure, thus preventing gas flow without coolant and the formation of unnecessary coolant clouds.

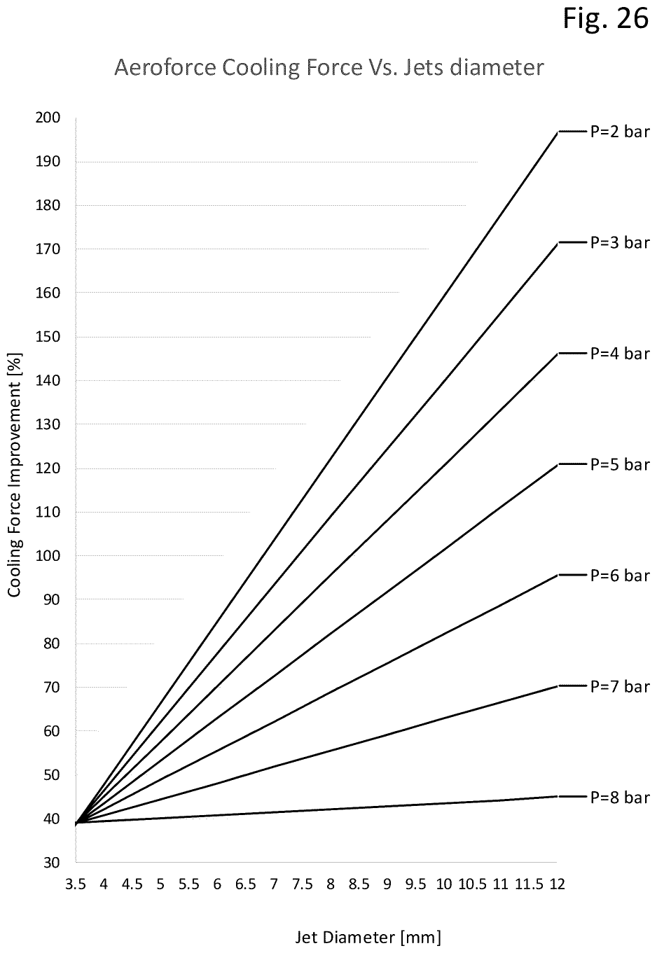

FIG. 26 is a detailed graph that describes the stagnation force exerted by the coolant at the exit of the nozzle. This graph provides a comparison of the improvement in stagnation force when the system is in use, as opposed to when the system is not utilized or when there is no gas pressure applied. The data in the graph clearly shows that the improvement in stagnation force, expressed in percentage terms, becomes more significant as the pressure of the coolant decreases. Additionally, the graph indicates that a larger nozzle diameter at the exit further enhances the stagnation force. These observations highlight the system's efficiency in optimizing coolant and gas pressure to achieve superior performance.

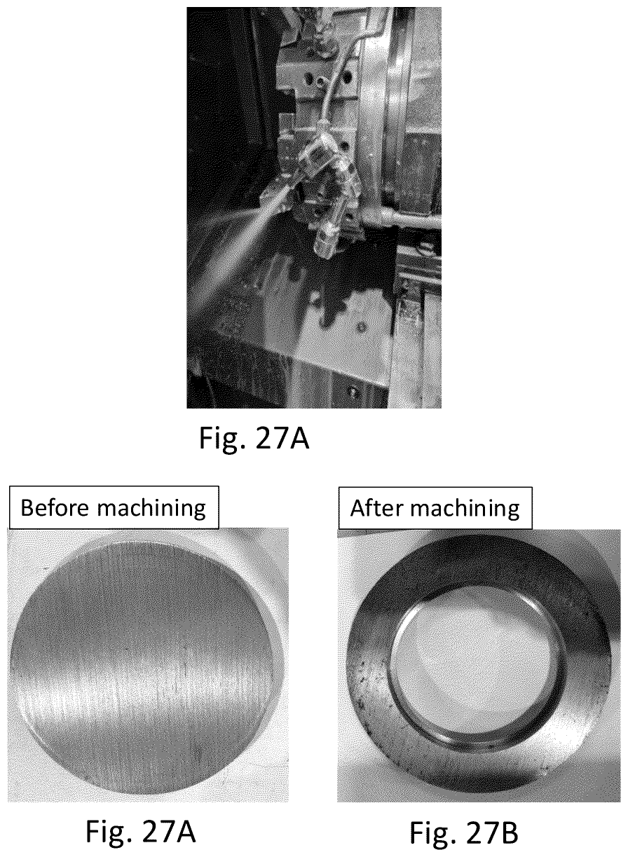

FIG. 27A illustrates the gas and liquid coolant (GLC) aeroforce device 1, 2 of the present invention, integrated in a process line, and FIGS. 27B-C illustrates a piece of metal before and after machining using the gas and liquid coolant (GLC) aeroforce device 1, 2 of the present invention.

As noted above, the gas and liquid coolant (GLC) aeroforce device 1, 2 of the present invention, provides powerful flow that optimally combines emulsion and air and provides a high flow coolant flow rate that minimizes friction, and thus, maximizes tool life.

The gas and liquid coolant (GLC) aeroforce device 1, 2 is characterized by excellent thermal control, meaning precise coolant delivery that minimizes heat build-up, thereby optimizing chip evacuation and maintaining surface finish.

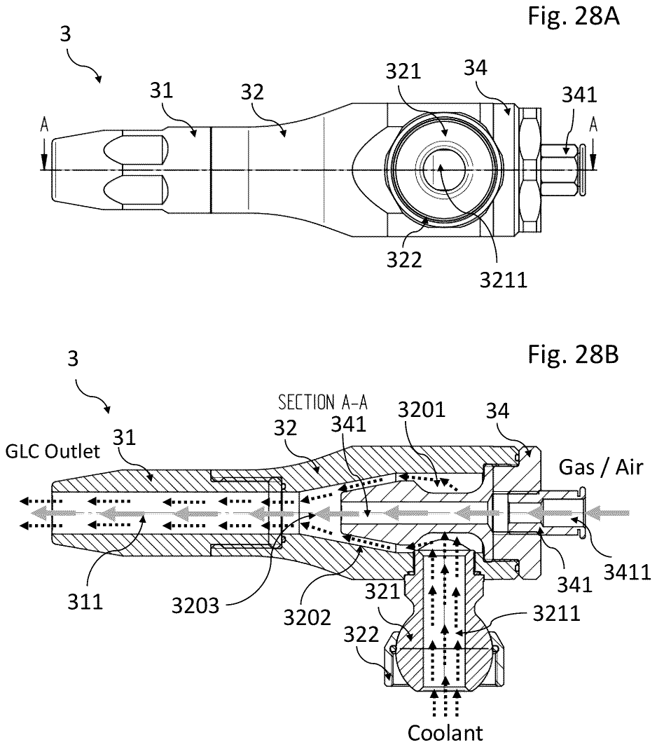

FIG. 28A illustrates a gas and liquid coolant (GLC) aeroforce device 3 comprises a nozzle portion 31, a base portion 32, a rear gas connector 34, and coolant inlet components 321 and 322. The nozzle portion 31 defines an outlet opening 311 through which a gas-liquid coolant (GLC) mixture is discharged toward a machining zone. The base portion 32 serves as a structural and functional core of the device and comprises an internal chamber 3201 configured to receive liquid coolant. The coolant inlet components 321 and 322 are configured to introduce liquid coolant into the device.

In accordance with some embodiments of the present invention, liquid coolant enters through an inlet opening 3211 formed in component 321 and is directed into the internal chamber 3201 within the base portion 32. In accordance with some embodiments of the present invention, the liquid coolant flows from the internal chamber 3201 through one or more tapered or conical passages 3202, which guide and accelerate the liquid toward an interaction region 3203. The rear gas connector 34 is configured to introduce pressurized gas into the device. The gas enters through an inlet opening 3411 formed in a gas connector element 341 and is directed into an internal passage 341 within the rear gas connector 34. As the gas flows through the passage 341, it accelerates and forms a directed gas stream, thereby generating a high-velocity gas jet. In accordance with some embodiments of the present invention, the liquid coolant emerging from the conical passages 3202 meets the gas stream at the interaction region 3203.

In accordance with some embodiments of the present invention, the interaction between the gas and the liquid coolant is defined by a gradual, non-acute angle, wherein both the gas flow and the liquid coolant flow are oriented in generally the same direction. This configuration differs from perpendicular or sharp-angle interaction geometries.

Due to this moderate, co-directional interaction, the pressurized gas induces a suction (entrainment) effect on the liquid coolant, causing the liquid to be drawn into and aligned with the gas stream. As a result, the liquid coolant attaches to the gas flow and is transported together with the gas stream toward the outlet opening 311 of the nozzle portion 31, forming a coherent and high-velocity gas-liquid coolant (GLC) jet.

This configuration enhances flow stability, improves momentum transfer between the gas and liquid phases, and enables efficient delivery of coolant to the machining zone, even under conditions of moderate liquid pressure.

FIG. 28B illustrates a cross-sectional view (section A-A) of the device shown in FIG. 28A, revealing the internal structure of the gas and liquid coolant (GLC) aeroforce device 3 according to some embodiments of the present invention. The internal geometry defines an interaction region between the gas flow and the liquid coolant flow, wherein the interface between the gas and the liquid is characterized by a gradual or non-acute angle. Unlike configurations in which the gas and liquid meet at a sharp or perpendicular angle, the configuration of the gas and liquid coolant (GLC) aeroforce device 3 employs a moderate, oblique interaction angle, enabling a smoother and more progressive interaction between the two phases. As the pressurized gas flows along this angled interface, it generates a localized pressure reduction along the liquid boundary, thereby inducing a suction (entrainment) effect that draws the liquid coolant into the gas stream. This configuration enhances momentum transfer while reducing flow separation and turbulence associated with sharp-angle interactions, thereby improving the stability and efficiency of the resulting gas-liquid coolant (GLC) flow.

In accordance with some embodiments of the present invention, the interaction angle may be defined within a range that avoids sharp transitions, thereby promoting controlled entrainment and improved flow coherence. In accordance with some embodiments of the present invention,

### PARTS & FEATURES DESCRIPTION

1. P1—Aeroforce model 1 for chain connection
2. P11—Aeroforce model 1 Outlet connection
3. P1101—Aeroforce model 1 outlet area.
4. P12—Aeroforce model 1 base assembly
5. P121—Aeroforce model 1 base.
6. P1211—Aeroforce model 1 radial gas bore in the base.
7. P1212—Aeroforce model 1 axial gas bore in the base
8. P1213—Aeroforce model 1 coolant radial slot.
9. P1214—Aeroforce model 1 axial coolant bores.
10. P1215—Aeroforce model 1 sharp edge
11. P122—Aeroforce model 1 gas inlet.
12. P1221—Aeroforce model 1 radial gas inlet bore.
13. P13—Aeroforce model 1 inlet connection assembly
14. P131—Aeroforce model 1 inlet ball connection.
15. P1311—Aeroforce model 1 inlet ball connection bore.
16. P132—Aeroforce model 1 inlet nut connection.
17. P2—Aeroforce model 2 with adjustable abilities.
18. P21—Aeroforce model 2 outlet base
19. P211—Aeroforce model 2 outlet base bore.
20. P212—Aeroforce model 2 outlet base external thread.
21. P213—Aeroforce model 2 outlet base coolant thread.
22. P214—Aeroforce model 2 outlet base coolant bores.
23. P22—Aeroforce model 2 coolant inlet base.
24. P221—Aeroforce model 2 coolant inlet base bore.
25. P222—Aeroforce model 2 coolant inlet base thread.
26. P23—Aeroforce model 2 coolant inlet base locking nut.
27. P231—Aeroforce model 2 coolant inlet base locking nut thread.
28. P24—Aeroforce model 2 coolant adjustable base.
29. P241—Aeroforce model 2 coolant adjustable base thread.
30. P242—Aeroforce model 2 coolant adjustable base pneumatic conical valve.
31. P25—Aeroforce model 2 gas adjustable base.
32. P251—Aeroforce model 2 gas adjustable base pneumatic axial bore.
33. P252—Aeroforce model 2 gas adjustable base pneumatic conical valve.
34. P2511—Aeroforce model 2 gas adjustable base pneumatic radial bore.
35. P26—Aeroforce model 2 gas inlet connection.
36. P261—Aeroforce model 2 gas inlet connection bore.
37. P262—Aeroforce model 2 gas inlet connection thread.
38. P271—Aeroforce model 2 outlet base rear seal.
39. P272—Aeroforce model 2 outlet base front seal.
40. P273—Aeroforce model 2 coolant adjustable base seal.
41. P274—Aeroforce model 2 gas adjustable base seal.
42. P281—Aeroforce model 2 coolant perpendicular throttle.
43. P282—Aeroforce model 2 gas conical throttle.
44. P31—Aeroforce model 3 GLC outlet
45. P311—Aeroforce model 3 GLC outlet bore
46. P32—Aeroforce model 3 base
47. P3201—Aeroforce model 3 base internal space
48. P3202—Aeroforce model 3 conical passage
49. P3203—Aeroforce model 3 GLC contact point
50. P321—Aeroforce model 3 coolant inlet
51. P3211—Aeroforce model 3 coolant inlet port
52. P322—Aeroforce model 3 coolant inlet port nut
53. P34—Aeroforce model 3 gas inlets
54. P341—Aeroforce model 3 pneumatic connection
55. P3411—Aeroforce model 3 pneumatic connection port

$$Coolant ( Liquid ) Equations \qquad Equations$$

$$P + ρ gh + \frac{1}{2} ρ {v}^{2} = const ( Bernoulli ’ s low )$$

$$Δ h = 0 \to P + \frac{1}{2} ρ {v}^{2} = const$$

$$P 1 + \frac{1}{2} ρ lV {1}^{2} = P 2 + \frac{1}{2} ρ lV {2}^{2}$$

$$V 1 = 0 \to P 1 = P 2 + \frac{1}{2} l ρ V {2}^{2}$$

$$Δ P = P 1 - P 2$$

$$V 2 = \sqrt{\frac{2 ( P 1 - P 2 )}{ρ l}} = \sqrt{\frac{2 Δ P}{ρ l}}$$

$$Vl = V 2 \cdot kl \to V = kl \sqrt{\frac{2 Δ P}{ρ l}}$$

$${Vl}^{2} = \frac{2 \cdot Δ P \cdot {kl}^{2}}{ρ l}$$

$$Al = \frac{π ( D {1}^{2} - D {2}^{2} )}{4} ( conical end cross section )$$

$$Ql = Vl \cdot Al = \frac{π V ( D {1}^{2} - D {2}^{2} )}{4} = \frac{π ( D {1}^{2} - D {2}^{2} ) \cdot kl \sqrt{2 Δ P}}{4 \sqrt{p}}$$

$$Ml = Ql \cdot ρ l = \frac{π ρ l V ( D {1}^{2} - D {2}^{2} )}{4} = \frac{π ( D {1}^{2} - D {2}^{2} ) \cdot kl \sqrt{2 ρ l Δ P}}{4}$$

$$Gas ( Air ) Equations$$

$$Vmax = \sqrt{2 CpTt}$$

$$Δ Pa = Pa 1 - Pa 2$$

$$Va 2 = 343 m / s @ Δ Pa > 2 E 5 Pa ( Chocked air flow max velocity )$$

$$Va = Va 2 \cdot ka$$

$$Aa = \frac{π {D}^{2}}{4} ( single equivalent nozzle cross section )$$

$$Qa = Va \cdot Aa = \frac{π \cdot Va 2 \cdot ka \cdot {D}^{2}}{4}$$

$$Ma = Qa \cdot ρ a = \frac{π \cdot ρ a \cdot Va 2 \cdot ka \cdot {D}^{2}}{4}$$

Mathematical Symbols

| No. | Symbol | Description | Units |
|---|---|---|---|
| 1 | P1 | Hydraulic inlet Pressure | Pa |
| 2 | P2 | Hydraulic outlet Pressure | Pa |
| 3 | ΔP | Hydraulic differential Pressure | Pa |
| 4 | Pa1 | Pneumatic inlet Pressure | Pa |
| 5 | Pa2 | Pneumatic outlet Pressure | Pa |
| 6 | ΔPa | Pneumatic differential Pressure | Pa |
| 7 | V1 | Hydraulic tank (inlet) Velocity | m/s |
| 8 | V2 | Hydraulic theoretical outlet Velocity | m/s |
| 9 | VI | Hydraulic actual outlet Velocity | m/s |
| 10 | Va2 | Pneumatic theoretical outlet Velocity | m/s |
| 11 | Va | Pneumatic actual outlet Velocity | m/s |
| 12 | Al | Hydraulic equivalent cross section | m² |
| 13 | Aa | Pneumatic cross section | m² |
| 14 | kl | Hydraulic discharge coefficient | [ ] |
| 15 | ka | Pneumatic discharge coefficient | [ ] |
| 16 | ρl | Hydraulic (coolant) Density | Kg/m³ |
| 17 | ρa | Pneumatic (air) Density | Kg/m³ |
| 18 | D1 | Hydraulic external Diameter (constant) | m |
| 19 | D2 | Hydraulic internal Diameter (variable) | m |
| 20 | D | Pneumatic nozzle Diameter | m |
| 21 | QI | Hydraulic volume flow rate | m³/s |
| 22 | Qa | Pneumatic volume flow rate | m³/s |
| 23 | MI | Hydraulic mass flow rate | Kg/s |
| 24 | Ma | Pneumatic mass flow rate | Kg/s |
| 25 | g | Gravitation acceleration (N/A) | m/s² |
| 26 | h | Initial hydraulic height (N/A) | m |
| 27 | Δh | Differential height (N/A) | m |

1. A gas and liquid coolant (GLC) aeroforce device for generating non aerosol liquid and gas coolant (GLC), leveraging gas and liquid pressure, and ensuring optimal cooling and lubrication, said device featuring high-velocity coolant convergence with either a moderate or sharp transition directing liquid in an annular or non-annular trajectory towards a central or non-central location, said device creates a mixture of pressurized gas and liquid coolant at a convergence, enhancing cooling, lubrication, and chip clearance in metalworking machinery and other applications.

2. The gas and liquid coolant (GLC) aeroforce of claim 1 comprising:
gas and liquid coolant exit component; wherein, in said gas and liquid coolant exit component liquid is integrated with pressurized gas to create a high-pressure coolant,
pressurized gas introduction component through which pressurized gas enters the gas and liquid coolant (GLC) aeroforce device;
coolant introduction component through which liquid enters the gas and liquid coolant (GLC) aeroforce device; said coolant introduction component comprising at least one passage to facilitate flow of said liquid to said gas and liquid coolant exit component and an edge element located in proximity to an exit point of said at least one passage,
wherein said edge element altering the movement dynamics of the liquid coolant as the liquid emerges from the at least one passage, the edge element redirecting the liquid's movement from its initial axial flow direction to a radial trajectory directed toward a desired location, and
wherein as the liquid converges toward a desired location, it is interfacing with an introduced pressurized gas,
thereby the liquid-gas interface is transformed into the gas and liquid coolant intended for cooling and lubrication.

3. The gas and liquid coolant (GLC) aeroforce device of claim 2, wherein said edge element is a sharp edge element.

4. The gas and liquid coolant (GLC) aeroforce device of claim 2, wherein said desired location is in a pivotal component.

5. The gas and liquid coolant (GLC) aeroforce device of claim 2, wherein said at least one passage is at least one axial bore designed to facilitate the flow of liquid from said coolant introduction component of said liquid to said gas and liquid coolant exit component.

6. The gas and liquid coolant (GLC) aeroforce device of claim 2, wherein the gas is directed into the gas and liquid coolant (GLC) aeroforce device through a connector situated within the pressurized gas introduction component.

7. The gas and liquid coolant (GLC) aeroforce device of claim 2, wherein said coolant introduction component further comprises an outlet ball connection designed to establish a robust and secure connection between the coolant introduction component and a transportation pipeline to ensure a reliable flow the coolant.

8. The gas and liquid coolant (GLC) aeroforce device of claim 7, wherein said coolant introduction component further comprises an outlet nut connection designed to ensure a reliable flow of coolant.

9. The gas and liquid coolant (GLC) aeroforce device of claim 2, further comprising means for adjusting the coolant flow and/or the gas flow to optimize system performance in relation to actual infrastructure conditions.

10. The gas and liquid coolant (GLC) aeroforce device of claim 9, wherein said means for adjusting the coolant flow and/or the gas flow are screws allowing for the narrowing of liquid passage and gas passage.

11. The gas and liquid coolant (GLC) aeroforce device of claim 2, wherein said gas and liquid coolant (GLC) aeroforce device incorporates hexagonal elements which are accessible to a user for adjustments of the liquid pressure, and the gas pressure.

12. The gas and liquid coolant (GLC) aeroforce device of claim 2, further comprises multiple gaskets to seal the components, thus, to prevent premature mixing of the coolant and gas, and/or to prevent unwanted coolant leakage.

13. The gas and liquid coolant (GLC) aeroforce device of claim 2, wherein the gas flows in the center of the gas and liquid coolant (GLC) aeroforce device and the liquid flows around the gas in at least one designated passage, said liquid meets the gas either at a sharp or perpendicular angle or at a gradual or non-acute angle which enables smooth and progressive interaction between the gas and the liquid.

14. The gas and liquid coolant (GLC) aeroforce device of claim 13, wherein the gas flows in the center of the gas and liquid coolant (GLC) aeroforce device and the liquid meets the gas vertically.

15. The gas and liquid coolant (GLC) aeroforce device of claim 2, wherein the liquid flow speed and/or the gas flow speed is increased by reducing the cross-sectional area of the at least one passage.

16. The gas and liquid coolant (GLC) aeroforce device of claim 2, wherein the coolant and the pressurized gas enter into the gas and liquid coolant (GLC) aeroforce device concurrently, the gas enters through a designated port located within a gas connector, said gas traverses through a passage culminating in its arrival at a central bore, while the coolant enters through a designated opening and passes through at least one passage and enters into a coolant radial slot, a pivotal axisymmetric region, and continues to a space where gas and liquid culminate in the creation of GLC.

17. The gas and liquid coolant (GLC) aeroforce device of claim 2, wherein said gas and liquid coolant (GLC) aeroforce device is connected to a dedicated pneumatic valve or a standard pneumatic valve to manage a synchronized delivery of gas and coolant, said dedicated pneumatic valve or a standard pneumatic valve halts gas pressure immediately when the coolant pressure stops to prevents unnecessary gas consumption and to avoid formation of clouds inside a machine, ensuring efficient operation.

18. The gas and liquid coolant (GLC) aeroforce device of claim 2, wherein a check valve is used to prevent coolant flow into the gas pressure system.

19. The gas and liquid coolant (GLC) aeroforce device of claim 2, wherein a control valve is used to allow for disconnecting the gas pressure supply when there is no coolant pressure, thus preventing gas flow without coolant and the formation of unnecessary coolant clouds.

20. The gas and liquid coolant (GLC) aeroforce device of claim 2, wherein the gas and liquid coolant (GLC) aeroforce device comprises components made of metals and/or alloys.
